(19) United States
(12) Patent Application Publication
(10) Pub. No.: US 2002/0134852 A1
(43) Pub. Date: Sep. 26, 2002

(54) Fuel injection valve

(76) Inventor: Karl Hofmann, Villingendorf (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/958,695

(22) PCT Filed: Feb. 6, 2001
(86) PCT No.: PCT/DE01/00449

(30) Foreign Application Priority Data
Feb. 11, 2000 (DE) 100 06 111.7

(51) Int. Cl. F02M 47/02

(52) U.S. Cl. 239/88

(57) ABSTRACT

In a fuel injection valve having a valve body (10), having a control pressure chamber (16) embodied in it and closed on one side by an actuating part (14) for a nozzle needle (12), which needle, controlled by the actuating part, is displaceable between a closing position and an opening position, having an inlet (18) to the control pressure chamber and an outlet (20) out of the control pressure chamber, the outlet being controlled by a control valve (24), in which the injected fuel quantity is metered with high precision. To that end, a displaceable throttle piston (32) is provided, which in a first position enables a partial opening stroke of the nozzle needle out of the closing position counter to a slight resistance, and in a second position enables a remaining opening stroke, immediately following the partial opening stroke, of the nozzle needle (12) into the opening position only counter to a higher resistance.

### PRIOR ART

The invention relates to a fuel injection valve having a valve body, having a control pressure chamber embodied in it and closed on one side by an actuating part for a nozzle needle, which needle, controlled by the actuating part, is displaceable between a closing position and an opening position, having an inlet to the control pressure chamber and an outlet out of the control pressure chamber, the outlet being controlled by a control valve.

One such control valve is known from German Patent Disclosure DE 197 27 896 A1, for instance, and serves to bring about the opening of a nozzle needle of the injection valve, in order to inject fuel into a cylinder of an internal combustion engine.

The nozzle needle is permanently acted upon by an opening pressure, which seeks to lift the nozzle needle from the associated valve seat. Counteracting this opening force is a closing force, which is exerted on the actuating part in the control pressure chamber. As long as the pressure in the control pressure chamber is kept at a high level, the closing force generated there is higher than the opening force acting on the nozzle needle, so that the actuating part remains in the closing position, and consequently the nozzle needle remains closed. If conversely the pressure in the control pressure chamber and consequently the closing force generated there as well drops, then the opening force succeeds in displacing the actuating part into the opening position, and as a result the nozzle needle can lift from the valve seat. Fuel can now be injected.

The pressure in the control pressure chamber is controlled by the control valve, in that the outlet is closed or opened. If by closure of the outlet the medium, typically fuel, delivered to the control pressure chamber is dammed up, then a high pressure is generated in the control pressure chamber and keeps the nozzle needle in a closed state. If conversely the control valve opens the outlet, the pressure in the control pressure chamber drops, so that the nozzle needle can open.

To enable injecting different fuel quantities as a function of various operating conditions, it is desirable for the nozzle needle to be able to execute a controlled partial opening stroke, that is, a stroke that is shorter than a complete opening stroke, out of the closing position into the opening position. The course and magnitude of such a partial opening stroke depends in particular on the throttling action of the inlet to the control pressure chamber and of the outlet out of the control pressure chamber, on the pressure buildup at the various points of the nozzle, on the temperature, on the masses moved, and above all on the friction of the parts in motion. Because there are so many parameters, there is typically a comparatively wide variation in the injection quantity in a partial opening stroke.

The object of the invention is to further develop a fuel injection valve of the type recited at the outset such that the injection quantity can be controlled more precisely in the event of a partial opening stroke of the nozzle needle.

### ADVANTAGES OF THE INVENTION

The control valve of the invention having the characteristics of the body of claim 1 has the advantage that at the end of the partial opening stroke of the nozzle needle, a considerable increase in the resistance results, which counteracts further opening of the nozzle needle. The result is a pronounced threshold between a lesser opening force, which leads only to a partial opening stroke of the nozzle needle, and a higher opening force, which leads to a complete opening stroke of the nozzle needle, which makes a precise, partly opened state of the nozzle needle possible.

In a first embodiment of the invention, it is provided that the throttle piston is disposed in the outlet from the control pressure chamber and is provided with a throttle bore, and the transition of the throttle piston from the first position to the second position is defined in that the throttle piston comes into contact with a stop. In this embodiment, the throttle piston is adjusted during the partial opening stroke by the fluid flowing out of the control pressure chamber. As long as the throttle piston is not in contact with the stop, only comparatively slight resistance is presented to the outflow of fluid from the control pressure chamber; only once the throttle piston is resting on the stop is the fluid that leaves the control pressure chamber forced to flow through the throttle bore. As a result, a greater resistance is presented to a further opening stroke of the nozzle needle. The length of the partial opening stroke of the nozzle needle can be adjusted in this embodiment at little effort by means of a suitable choice of the cross section of the throttle piston and of the possible stroke up to the stop.

In a second embodiment of the invention, it is provided that the throttle piston is disposed between the actuating part and the nozzle needle and is provided with a groove, which cooperates with a control edge, and the transition of the throttle piston from the first position to the second position is defined in that the control edge enters into overlap with the groove. In this embodiment, the throttle piston forms a slide, which by closing the groove closes an outflow from a chamber into which the nozzle needle protrudes and out of which it must positively displace fluid if further opening takes place. The length of the partial opening stroke can thus be determined directly by the spacing existing, when the nozzle needle is closed, between the end of the groove and the control edge.

### DRAWINGS

The invention is described below in terms of two embodiments, which are shown in the accompanying drawings. Shown in them:

FIG. 1, a schematic view of a fuel injection valve of the prior art;

FIG. 2, in an enlarged view, part of the fuel injection valve of FIG. 1;

FIG. 3, a view corresponding to that of FIG. 2 showing a detail of a fuel injection valve in a first embodiment of the invention; and

FIG. 4, in an enlarged view corresponding to the detail injection valve of FIG. 1, a detail of a fuel injection valve in a second embodiment of the invention.

### DESCRIPTION OF THE EXEMPLARY EMBODIMENTS

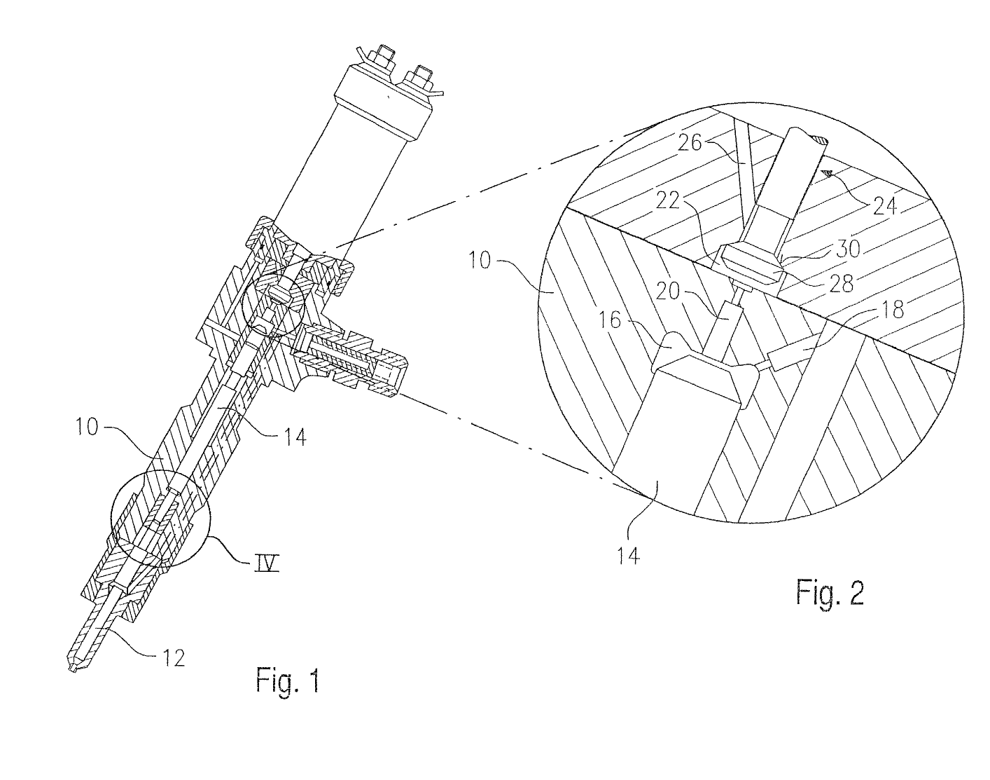

In FIG. 1, a conventional fuel injection valve with a control valve (see FIG. 2) is shown. The fuel injection valve has a valve body 10, in which a nozzle needle 12 is displaceably mounted. The nozzle needle 12 controls the injection of fuel into a cylinder of an internal combustion engine (not shown). The delivered fuel exerts an opening force on the nozzle needle 12 that seeks to adjust both the nozzle needle and an actuating part 14, on which the nozzle needle 12 is braced, toward a control pressure chamber 16.

The control pressure chamber 16 is also supplied with fuel, which because of the pressure prevailing in the control pressure chamber 16 exerts a closing force on the actuating part 14. The fuel is furnished via an inlet 18, and from the control pressure chamber 16 an outlet 20 extends to a control chamber 22 of a control valve 24. For the control valve 24, the outlet 20 acts as the inlet, and an outlet 26 is provided, through which the fuel can flow out of the control pressure chamber 16 and the control chamber 22.

In the control chamber 22, the control valve 24 has a valve needle 28, which cooperates with a valve seat 30. When the valve needle 28 is in contact with the valve seat 30, the control valve 24 is closed, so that the fuel delivered to the control pressure chamber 16 via the inlet 18 is dammed up in this chamber. The high pressure generated in this way exerts a closing force on the actuating part 14 that is greater than the opening force acting on the nozzle needle 12. The actuating part 14 is thus in the closing position, and the fuel injection valve is closed. If conversely the valve needle 28 is lifted from the valve seat 30, the fuel can flow out of the control pressure chamber 16 via the control chamber 22 and the outlet 26, so that the pressure in the control pressure chamber drops. The then-reduced closing force makes it possible for the actuating part to adjust out of the closing position into the opening position, so that the nozzle needle opens. Fuel is now injected.

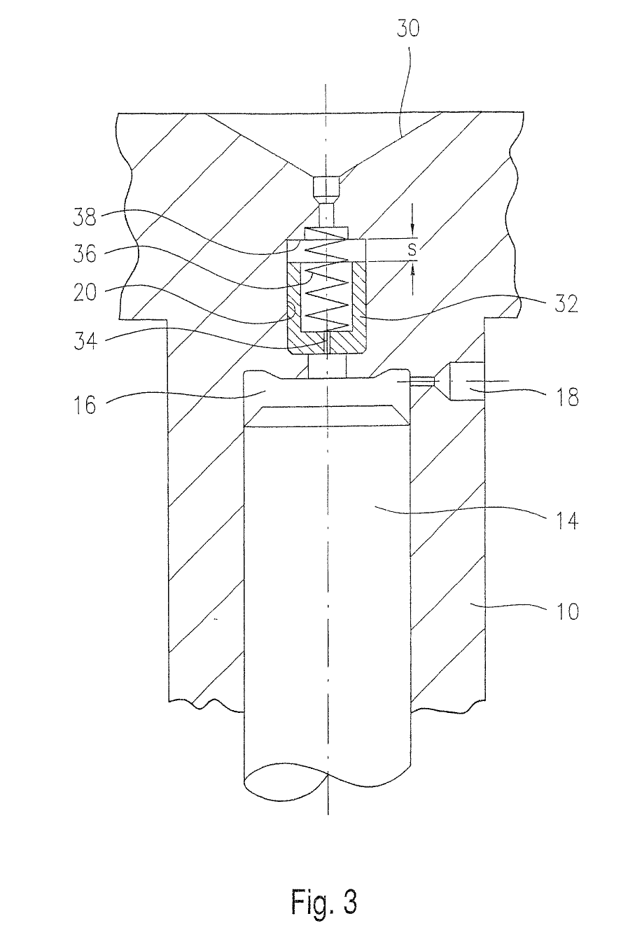

A fuel injection valve in accordance with a first embodiment of the invention will be described below in conjunction with FIG. 3. In the fuel injection valve of the first embodiment, a throttle piston 32, which is provided with a throttle bore 34, is disposed in the outlet from the control pressure chamber 16. The throttle piston is urged by a spring 36 into the outset position shown in the drawing, in the direction toward the actuating part 14. The throttle piston 32 is displaceable in the outlet 20, counter to the action of the spring 36, by a distance s; after a displacement by the stroke s, the throttle piston 32 comes into contact with a stop 38.

The injection valve described functions as follows: When the valve needle (not shown in FIG. 3) is lifted from the valve seat 30, the fluid furnished via the inlet 18 can flow out of the control pressure chamber 16. In the process, the throttle piston 32 is carried along out of its first position shown in FIG. 3, counter to the action of the spring 36, since the flow through the throttle bore 34 can initially be ignored. The fluid flowing out of the control pressure chamber 16 enables the actuating part 14 to adjust upward in terms of FIG. 3, so that the nozzle needle opens.

The outflow of fluid from the control pressure chamber 16 is counteracted by a comparatively slight resistance until such time as the throttle piston 32 has executed the stroke s, so that it is in contact with the stop 38 and is in its second position. If fluid is now supposed to continue to flow out of the control pressure chamber 16, so that the actuating part 14 can be opened farther, this is possible only if the fluid flowing out of the control pressure chamber flows through the throttle bore 34 by overcoming the applicable flow resistance. Within the desired brief opening time, this is possible only if a suitably strong opening force is exerted on the nozzle needle.

The resultant pronounced transition from a state in which a displacement of fluid out of the control pressure chamber 16 experiences only slight resistance to a state in which high resistance counteracts such a displacement makes a precisely defined partial stroke possible. This partial stroke ends as soon as the throttle piston 32 is in contact with the stop 38. The length of the partial stroke can be adapted in a simple way by providing that the stroke s and the cross-sectional area of the throttle piston 32 are selected such that the thus-defined volume corresponds to the volume which is positively displaced out of the control pressure chamber 16 by the actuating part 14 at the desired partial opening stroke.

An advantageous side effect of the described design is that the vibration behavior of the actuating part can be varied, and thus the wear performance of the actuating part and the nozzle needle can be improved.

In a departure from the embodiment shown, it is also possible, instead of the throttle bore, to employ a gap between the outer wall of the throttle piston 32 and the inner wall of the outlet 20; this gap furnishes the applicable flow resistance for the fluid flowing out of the control pressure chamber 16.

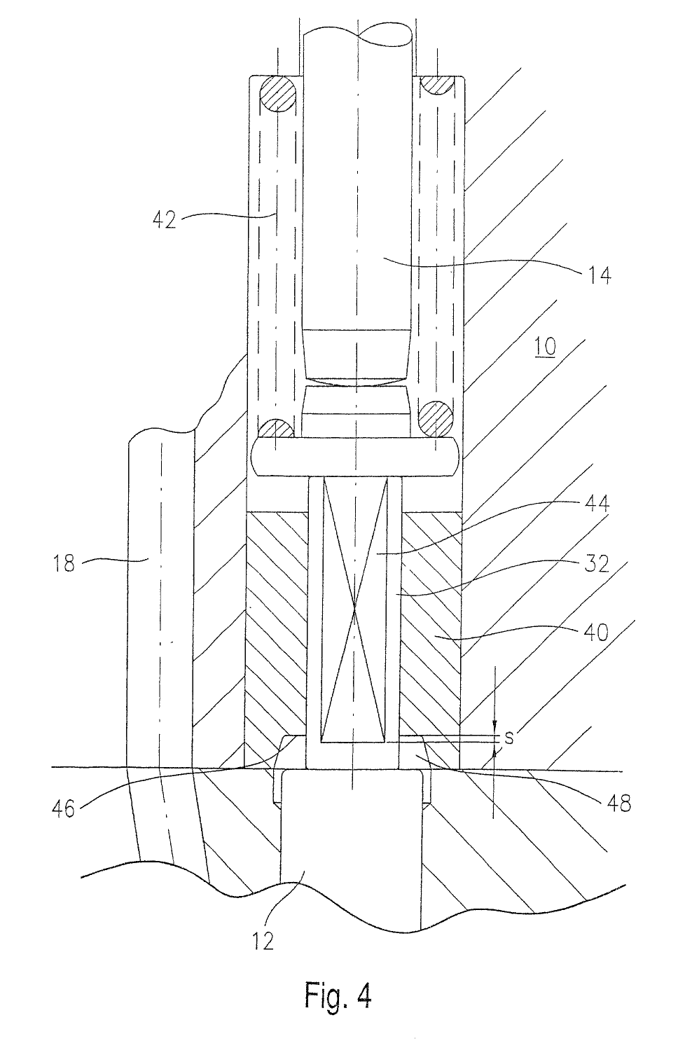

A fuel injection valve in a second embodiment of the invention will now be described in conjunction with FIG. 4. For those components that are known from the preceding description, the same reference numerals will be used, and reference is made to the explanations provided above.

In this embodiment, the throttle piston 32 is disposed displaceably in a guide sleeve 44, which is press-fitted into the valve body 10 between the actuating part 14 and the nozzle needle 12. The throttle piston 32 rests directly, with its lower end in terms of FIG. 4, on the nozzle needle 12, while the actuating part 14 is braced on its upper end, again in terms of FIG. 4. Also braced on the throttle piston 32 is a nozzle spring 42, which urges the nozzle needle 12 into its closing position. Since the actuating part is not braced directly on the nozzle needle, lateral forces cannot be transmitted from the actuating part to the nozzle needle.

The throttle piston 32 is provided with a groove 44, which is embodied as a ground, plane face on the outer wall of the throttle piston 32. The groove 44 cooperates with a control edge 46, which is formed by the edge toward the nozzle needle 12 of the guide sleeve 40. A leakage collection chamber 48 into which the throttle piston protrudes is disposed between the nozzle needle and the edge of the guide sleeve 40.

The injection valve described functions as follows: When the closing force exerted in the control pressure chamber on the actuating part 14 decreases, the opening force acting on the nozzle needle 12 lifts the nozzle needle from its nozzle seat, so that it is adjusted upward, in terms of FIG. 4, counter to the action of the nozzle spring 42. The fluid present in the leakage collection chamber 48 can escape through the groove 44, as long as the lower end of the groove 44 is located below the control edge. As soon as the throttle piston 32 has been displaced by the stroke s, the control edge 46 closes the groove 44, so that the fluid present in the leakage collection chamber 48 can now escape only through the play between the throttle piston 32 and the guide sleeve 40.

In this embodiment as well, a sharp rise in the requisite opening force occurs, once the nozzle needle 12 has executed a partial opening stroke and accordingly the throttle piston 32 has been displaced from its first position, in which the groove 44 is freely accessible, into its second position, in which the groove 44 is covered by the control edge 46. In a distinction from the first embodiment, the stroke s that the throttle piston 32 executes until the control edge closes the groove corresponds exactly here to the partial opening stroke of the nozzle needle; in the first embodiment, if different cross sections are chosen for the actuating part 14 and the throttle piston 32, a hydraulic step-up of the travel conditions can result.

1. A fuel injection valve having a valve body (10), having a control pressure chamber (16) embodied in it and closed on one side by an actuating part (14) for a nozzle needle (12), which needle, controlled by the actuating part, is displaceable between a closing position and an opening position, having an inlet (18) to the control pressure chamber and an outlet (20) out of the control pressure chamber, the outlet being controlled by a control valve (24), characterized in that a displaceable throttle piston (32) is provided, which in a first position enables a partial opening stroke of the nozzle needle out of the closing position counter to a slight resistance, and in a second position enables a remaining opening stroke, immediately following the partial opening stroke, of the nozzle needle (12) into the opening position only counter to a higher resistance.

2. The injection valve of claim 1, characterized in that the throttle piston is disposed in the outlet (20) from the control pressure chamber (16) and is provided with a throttle bore (34), and the transition of the throttle piston from the first position to the second position is defined in that the throttle piston comes into contact with a stop (38).

3. The injection valve of claim 2, characterized in that a spring (36) is provided, which urges the throttle piston toward the actuating part.

4. The injection valve of claim 1, characterized in that the throttle piston (32) is disposed between the actuating part (14) and the nozzle needle (12) and is provided with a groove (44), which cooperates with a control edge (46), and the transition of the throttle piston from the first position to the second position is defined in that the control edge (46) enters into overlap with the groove (44).

5. The injection valve of claim 4, characterized in that the groove (44) is defined by a plane face, which is ground into the wall of the throttle piston (32).
